(19) United States
(12) Patent Application Publication
(10) Pub. No.: US 2024/0149233 A1
(43) Pub. Date: May 9, 2024

(54) HEATED AUGER ASSEMBLY AND METHOD OF USE

(71) Applicant: Turf Care Supply, LLC, Brunswick, OH (US)

(72) Inventors: Brian Mengeu, TRIADELPHIA, WV (US); Travis Edwards, WHEELING, WV (US); David Perzanowski, SHADYSIDE, OH (US); LESTER WILLIAM Young, JACOBSBURG, OH (US); Logan Pelley, MCMECHEN, WV (US); Mark Mangan, Medina, OH (US)

(21) Appl. No.: 18/501,657

(22) Filed: Nov. 3, 2023

Related U.S. Application Data
(60) Provisional application No. 63/422,211, filed on Nov. 3, 2022.

(51) Int. Cl. B01F 35/91

(52) U.S. Cl. CPC B01F 35/91

(57) ABSTRACT

The present invention describes a heated auger assembly and method for applying powder or liquid, such as efficacious concentrations of DCD, to a substrate granule, such as granular urea. The heated auger assembly includes a mixing auger comprising a first and second end, and at least one of a heat applicator. The method of applying powder and/or liquid raw material to a substrate granule includes heating the substrate granules in a pre-heater, such as a fluidized bed, then discharging the heated substrate granules from the pre-heater into a heated auger assembly, which applies heat to the substrate granules, facilitating the coating of the substrate granules with the powder and/or liquid raw material.

### CROSS-REFERENCE TO RELATED CASES

This case claims priority to, and the benefit of, U.S. Provisional Application Ser. No. 63/422,211, filed on Nov. 3, 2022 (Attorney Docket No. 31256.04099), the entire disclosure of which is incorporated herein by reference in its entirety as though fully recited herein.

### FIELD OF THE INVENTION

This disclosure generally relates to a heated auger assembly, a method for applying an additive, such as in granular, powdered, or liquid form, to a substrate granule, such as a fertilizer granule, and fertilizer products produced therefrom.

### BACKGROUND

Urea fertilizer is the most widely used fertilizer nitrogen (N) source worldwide. Its high nitrogen content (46%) makes it the most economical source on a per unit of N basis. However, urea is soluble and urea-nitrogen can be highly susceptible to loss to the environment depending on conditions. In particular, urea-N is susceptible to loss via ammonia volatilization, surface runoff, nitrate leaching, and denitrification of nitrate. These losses lead to inefficiency in nitrogen use which increases the effective cost per unit N to fertilizer users.

Urea can be treated with certain nitrogen stabilizers which affect the way urea is transformed in the soil. The net effect is that less nitrogen is lost to the environment and more remains available for plant uptake, increasing the efficiency of nitrogen use. One of these stabilizers in particular, the nitrification inhibitor dicyandiamide (DCD), must be applied with urea at a relatively high rate (approximately 1% by weight) in order to have positive agronomic effectiveness. One way to do this is to introduce granular DCD into the molten urea liquid stream prior to granulation (as described in U.S. Pat. Nos. 9,682,894, 9,790,136, and 9,394,210). This is an effective method, but it is limiting because granular DCD can only be introduced into the molten urea at the facility where the urea is manufactured.

### SUMMARY

The present invention relates to a heated auger assembly and method for applying at least one of a powder or liquid, such as efficacious concentrations of DCD, to a substrate, such as granular urea, or other granular substrates, after such substrates have been manufactured. The present invention also relates to a fertilizer product produced according to the foregoing method.

An exemplary embodiment of the heated auger assembly includes a mixing auger comprising a first and second end, a heating mechanism, such as a steam jacket, and optionally at least one of a steam injector. The mixing auger includes at least one granule substrate inlet proximate to the first end, a product outlet proximate to the second end, and at least one of a liquid, powdered or granular additive inlet therebetween. The heating mechanism, such as the steam jacket, comprises at least one of a steam line extending along the length of an outer surface of the mixing auger, wherein the steam within the steam line causes the temperature within the mixing auger to increase, thereby heating the contents, i.e., a granular substrate, such as fertilizer granules or other substrates described herein, to a temperature of approximately 150-240° F. The steam jacket, and optionally the at least one steam injector, apply heat to the granular substrate contained within the heated auger assembly to maintain an optimal elevated temperature as the granular substrate and powdered substrate are continually mixed and moved through the mixing auger. The steam jacket wraps around the outside surface of the heated auger assembly. The steam injectors insert steam into the mixing auger. In exemplary embodiments, the heated auger assembly includes at least one of a steam injector. In exemplary embodiments, the heated auger assembly includes three steam injectors. In some exemplary embodiments, the heated auger assembly further comprises one or more additional additive inlets, such as a liquid additive inlet, a colorant inlet, and/or a sealant inlet.

An exemplary method of applying powder or liquid additive to a substrate granule, such as fertilizer, includes first introducing the granular substrate into a pre-screener, which then feeds the granular substrate into a hopper. The hopper discharges the granular substrate through a metering device, such as a belt feeder, regulating flow to a pre-heater, such as a fluidized bed. The granular substrate is then discharged from the pre-heater into a heated auger assembly according to any of the embodiments described in further detail herein. In exemplary embodiments, the powdered or granular additive enters the heated auger assembly though the at least one powdered or granular additive inlet. In exemplary embodiments, powdered or granular additive, such as DCD powder, first passes through a mill to grind material to desired size. The ground powdered or granular additive is collected by a cyclone and discharged to the powder feeder, which regulates introduction of the powdered or granular additive to the heated auger assembly at a prescribed rate.

In exemplary embodiments, the heated auger assembly applies heat to the fertilizer or other substrate granules by way of the steam jacket and at least one steam injector, to maintain the desired temperature as the substrate granules and powdered or granular additive are continually mixed and moved through the mixing auger and facilitating the coating and bonding of the substrate granules with powdered or granular additive. In exemplary embodiments, the method includes application of additional additives or colorants onto the substrate granules within the mixing auger, as described further herein, prior to the product exiting the heated auger assembly through the product outlet. Such additional additives or colorants may include sealants, coatings, and/or colorants, in either powder or liquid form, or any combination thereof.

In exemplary embodiments, a fertilizer product comprises a substrate granule coated with DCD according to any of the exemplary methods described herein. Additives, such as DCD, applied to the surface of substrate granules, such as fertilizer granules, including urea, have typically been applied as liquid formulations, which limits the % active ingredient (AI) of the additive in or on the subsequent final product. The method and device disclosed herein produces a final product with an increased additive loading rate, and thus a much higher percentage of the AI than previously possible. The method and device disclosed herein are beneficial for the manufacture of substrate granules comprising certain additives, such as DCD, that require higher AI rates to function effectively.

A heated auger assembly comprises a mixing auger, comprising a first end and a second end, at least one substrate inlet proximate to the first end, a product outlet proximate to the second end, and at least one additive inlet between the first end and the second end; and a steam jacket surrounding at least a portion of an outer surface of the mixing auger, and at least one of a steam injector. In exemplary embodiments, the heated auger assembly includes three steam injectors. In exemplary embodiments, the steam jacket comprises at least one of a steam line extending along a length of the outer surface of the mixing auger, and wherein the steam jacket is capable of increasing the temperature within the mixing auger, such that a substrate contained within the heated auger assembly is heated to 150-240° F. as the substrate is moved through the mixing auger. In exemplary embodiments, the mixing auger further comprises a plurality of pitch lifting flights within an inner portion of the mixing auger. In exemplary embodiments, the mixing auger further comprises 15-30 pitch lifting flights. In exemplary embodiments, the mixing auger comprises the steam injector, and wherein the steam injector applies steam within the heated auger assembly at a pressure of 5-50 psi. In exemplary embodiments, the heated auger assembly further comprises at least one of a liquid additive inlet, a sealant inlet, and a colorant inlet between the first end and the second end. In exemplary embodiments, the heated auger assembly comprises a sealant inlet and a colorant inlet between the first end and the second end.

An exemplary process for coating a substrate with an additive, comprises providing a heated auger assembly according to any of the embodiments described herein, including a heated auger assembly comprising a mixing auger, comprising, a first end, a second end, a substrate inlet, an additive inlet, and a product outlet, and a steam jacket surrounding at least a portion of an outer surface of the mixing auger, introducing the substrate into the mixing auger through the substrate inlet, softening the outer surface of the substrate by applying heat within the mixing auger, wherein steam is introduced to the steam jacket, elevating the temperature within the steam jacket, thereby causing the temperature within the mixing auger to increase to 150-240° F.; introducing a granular additive into the mixing auger; and coating the substrate with the granular additive via rotation of the mixing auger, wherein the softening of the outer surface of the substrate facilitates an increased adhesion of the granular additive on the outer surface of the substrate. In exemplary embodiments, the process further comprises preheating the substrate to a temperature of 230-240° F. prior to introducing the substrate into the mixing auger. In exemplary embodiments, the substrate is a fertilizer granule or plant nutrient. In exemplary embodiments, the substrate is a granular urea. In exemplary embodiments, the additive is a powdered or finely granulated solid. In exemplary embodiments, the additive is granular dicyandiamide (DCD). In exemplary embodiments, the additive is any one of a solution, a slurry of suspended solids, or any other liquid form. In exemplary embodiments, the process further comprises coating the substrate with one or more of a solid additive, liquid additives, or a combination thereof. In exemplary embodiments, the process further comprises coating the substrate with granular additive thereon with at least one of a sealant additive. In exemplary embodiments, the sealant additive is added to the mixing auger following the addition of a solid additive and before the addition of a liquid additive. In exemplary embodiments, the mixing auger further comprises a plurality of pitch lifting flights within an inner portion of the mixing auger. In exemplary embodiments, the process further comprises applying steam into the mixing auger through at least one of a steam injector, and preferably three steam injectors, at a pressure of 10-15 PSI.

An exemplary process for coating a fertilizer substrate with an additive comprises providing a heated auger assembly, the heated auger assembly comprising: a mixing auger, comprising, a first end, a second end, a substrate inlet, an additive inlet, and a product outlet, and a steam jacket surrounding at least a portion of an outer surface of the mixing auger, and at least one of a steam injector; introducing the fertilizer substrate into the mixing auger through the substrate inlet, softening the outer surface of the fertilizer substrate by applying heat within the mixing auger, wherein steam is introduced to the steam jacket at 90 PSI at a feed rate of 5-10 tons per hour, elevating the temperature within the steam jacket, thereby causing the temperature within the mixing auger to increase to 150-240° F.; applying steam into the mixing auger through the at least one steam injector at a pressure of 10-15 PSI; introducing dicyandiamide (DCD) into the mixing auger at a rate of 20-25 lbs. DCD per ton of fertilizer substrate; and coating the fertilizer substrate with the DCD for 0.5-5 minutes by rotating the mixing auger at a rate of 20-60 revolutions per minute, wherein the softening of the outer surface of the fertilizer granule facilitated by the increased heat within the mixing auger increases the coating reception of the DCD thereon.

An exemplary coated fertilizer product comprises a substrate and an additive thereon prepared via any of the exemplary processes of coating a substrate described herein.

This Summary is provided merely for purposes of summarizing some exemplary embodiments to provide a basic understanding of some aspects of the disclosure. Accordingly, it will be appreciated that the above-described exemplary embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

Features, objects and advantages other than those set forth above will become more readily apparent when consideration is given to the detailed description below. Such detailed description makes reference to the following drawings:

FIG. 001 shows a schematic of an exemplary heated auger assembly;

FIG. 002 shows a schematic of the components used in an exemplary method of applying powder or liquid additive(s) to a granular substrate, including the heated auger assembly;

FIG. 003A is a detailed view of the second end of the mixing auger shown in FIG. 002;

FIG. 003B is a A-A′ cross sectional view of the mixing auger shown in FIG. 002; and

FIG. 004 shows a process flow chart of an exemplary method of applying powder or liquid additive to a fertilizer or other substrate granule using a heated auger assembly.

### DETAILED DESCRIPTION

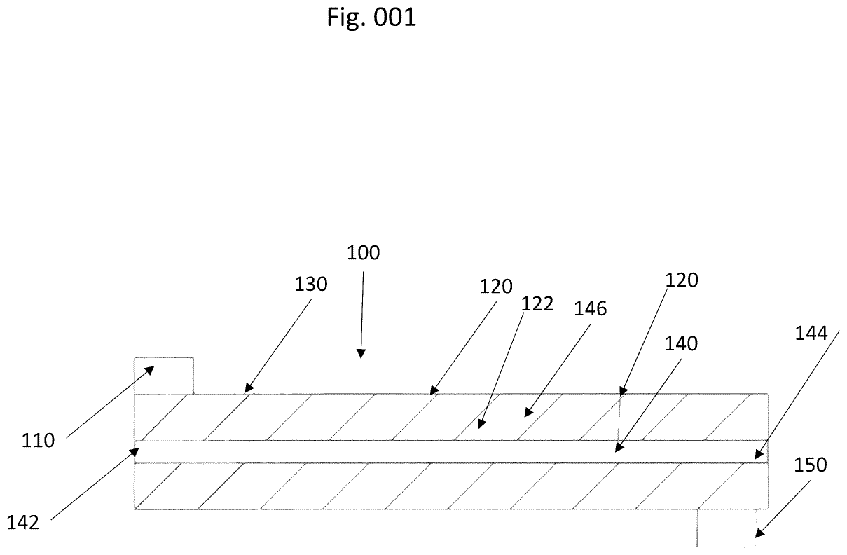

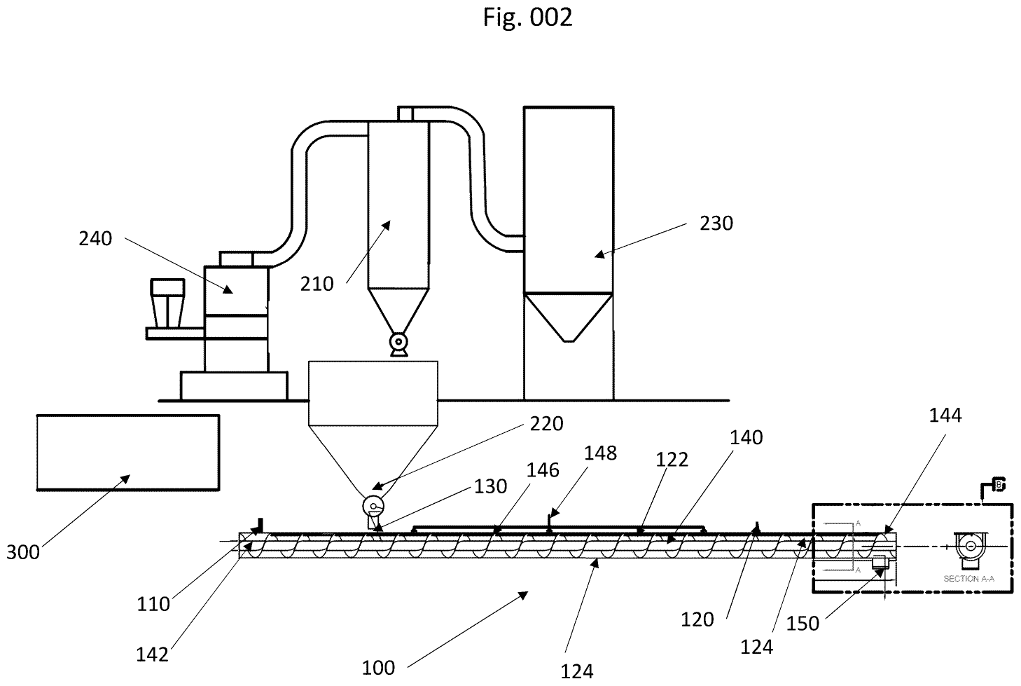

FIGS. 001 and 002 show schematic views of an exemplary heated auger assembly 100. An exemplary embodiment of the heated auger assembly 100 includes a mixing auger 140, and a means of applying heating to same. An exemplary embodiment of the heated auger assembly 100 includes a mixing auger 140 comprising a first end 142 and second end 144, a steam jacket 146, and optionally at least one of a steam injector 148. In exemplary embodiments, the mixing auger 140 includes at least one substrate inlet 110 proximate to the first end 142, a product outlet 150 proximate to the second end 144, and a one or more additive inlet(s) 130 therebetween. In exemplary embodiments, the heated auger assembly 100 comprises a steam jacket 146 comprising at least one of a steam line extending along the length of an outer surface of the mixing auger 140. In exemplary embodiments, steam within the steam jacket 146 causes the temperature within the mixing auger 140 to increase, thereby heating contents, i.e., substrate granules such as fertilizer granules, within the mixing auger 140 to an elevated temperature. In exemplary embodiments, said elevated temperature is approximately 150-240° F. In exemplary embodiments, the steam jacket 146, and optionally the at least one steam injector 148, can be used to apply heat to the substrate granules contained within the heated auger assembly 100 to maintain the desired temperature as the substrate granules and powdered or granular additive are continually mixed and moved through the mixing auger 140. Although use of steam is disclosed herein, in some exemplary embodiments the mixing auger 140 may be heated by any other means capable of providing heat thereto. In some exemplary embodiments, the heated auger assembly 100 further comprises at least one or more of an additive inlet 120, a colorant inlet 122, and/or at least one of a sealant inlet 124. In exemplary embodiments, the heated auger assembly 100 comprises each of an additive inlet 120, a colorant inlet 122 and two sealant inlets 124.

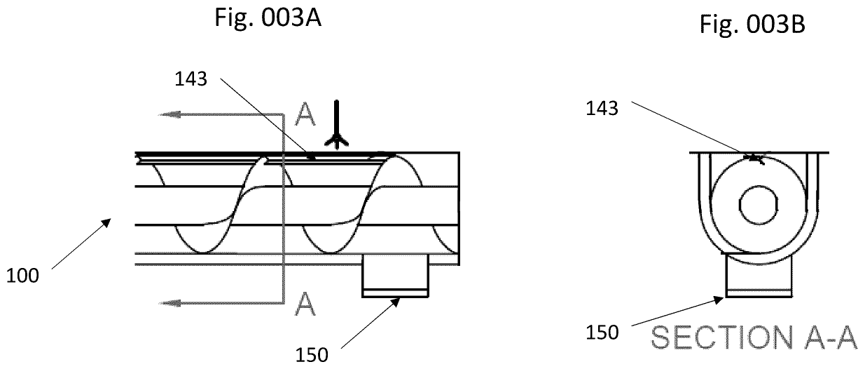

In exemplary embodiments, the mixing auger 140 is approximately 25 to 30 feet in length, and more preferably 28 feet in length. The mixing auger 140 has an outer diameter that is 8 to 14 inches in diameter, more preferably 12 inches. In exemplary embodiments, the mixing auger 140 further comprises a center shaft with a diameter of 1.5-5 inches, more preferably the center shaft is 3.5 inches in diameter. As shown in FIGS. 003A & 003B, in exemplary embodiments, the mixing auger 140 further comprises pitch lifting flights 143 to increase mixing that are welded between the flights of the auger. In exemplary embodiments, the auger has 10-30 total flights, preferably 15-25 flights, and more preferably 20 flights. In exemplary embodiments, the pitch lifting flight 143 have two adjacent legs each 0.5 to 5 inches in width, and more preferably 1 inch in width, located near the outer diameter of the pitch lifting flights 143. In exemplary embodiments, the pitch lifting flight 143 extends the length of the pitch. In exemplary embodiments, the mixing auger 140 comprises 10-50 pitch lifting flights 143, preferably 15-30 pitch lifting flights 143, and more preferably 20-25 pitch lifting flights 143. In exemplary embodiments, the mixing auger 140 comprises 20 flights with 24 pitch lifting flights 143 welded between then within the length of the mixing auger 140. In exemplary embodiments, the mixing auger 140 rotates at an average rate of 20-55 rotations per minute (RPM). In some exemplary embodiments, the mixing auger 140 rotates at an average rate of 48 RPM. In exemplary embodiments, the mixing auger 140 has a capacity of approximately 1-30 tons per hour (TPH), preferably 4-22 TPH.

In exemplary embodiments, the pressure within the steam lines comprising the steam jacket 146 is 40-90 psi. In some exemplary embodiments, the pressure within the steam lines comprising the steam jacket 146 is 60-90 psi, and more preferably 90 psi. In some exemplary embodiments, at least one of a steam injector 148 applies steam within the heated auger assembly 100 at a pressure of 5-50 psi, and more preferably 10-40 psi. The steam applied to the heated auger assembly 100, both from the steam jacket 146 and the optional steam injector 148, increases the temperature within the mixing auger 140 to approximately 150-240° F., and preferably 215° F., thereby increasing the temperature of substrate granules within the mixing auger 140 to approximately 150-240° F., and preferably 215° F. In exemplary embodiments, the powdered or granular additive is fed to the heated auger assembly 100 at a rate of approximately 5-100 pounds per ton (lbs/ton) of substrate granule, and preferably 21-42 lbs/ton of substrate granule.

In exemplary embodiments, the heated auger assembly 100 facilitates the application of additives onto a substrate granule, such as fertilizer granules. The elevated temperature within the mixing auger 140, created by the steam jacket 146 and the optional at least one steam injector 148, increases the temperature of the substrate granules with the mixing auger 140, thereby softening the surfaces of said substrate granules. The softened surfaces of the substrate granules allow for increased adhesion and bonding of the powdered or granular additive onto and into the granular substrate granules' surface when compared to substrate granules not subject to an elevated temperature. The substrate granules may comprise any fertilizer granules capable of softening when subjected to an elevated temperature, including granular urea, ammonium sulfate, calcium nitrate, potassium nitrate or other certain fertilizers. In exemplary embodiments, the fertilizer granules comprise granular urea. The substrate granules may also comprise any inert carrier capable of being softened by heat application, including but not limited to ammonium sulfate, paper, wax, or pulp.

The additive may comprise any additive which, when incorporated into the fertilizer product, would increase the utility and value of the fertilizer granule, including powder, liquid or granular additives such as finely ground granular material including DCD, other plant nutrients (especially micronutrients), biochar or char, biostimulants, amino acids, humic substances, microbial inoculum, or a variety of other substances that are beneficial to plant health or as soil amendments. In exemplary embodiments, the powdered or granular additive comprises powdered DCD.

In some exemplary embodiments, the heated auger assembly 100 further comprises at least one of a liquid additive inlet 120, a sealant inlet 124, and a colorant inlet 122 through which liquid and/or powder coatings, such as colorants, sealants, and adhesives, can be applied to the fertilizer product. Liquid additives may comprise sealants, adhesives, nitrogen stabilizing urease inhibitors, including, N-(n-butyl)thiophosphoric triamide (NBPT), or other liquid nitrogen stabilizers; liquid fertilizer formulations, especially micronutrients; biostimulant compounds such as amino acids, humic acids, fulvic acids, seaweed extracts, or sugars; soil surfactants; or other substances beneficial to plant health or as soil amendments. Color coatings may include dyes or colorants in liquid or powder form. In some exemplary embodiments, liquid additives are applied to the fertilizer product through the liquid additive inlet 120 and/or the sealant inlet 124 at a rate of approximately 1-25 lbs/ton of fertilizer granule, and preferably 5-7 lbs/ton of fertilizer granule. In some exemplary embodiments, color coatings are applied to the fertilizer product through the colorant inlet 122 at a rate of approximately 1-25 lbs/ton of fertilizer granule.

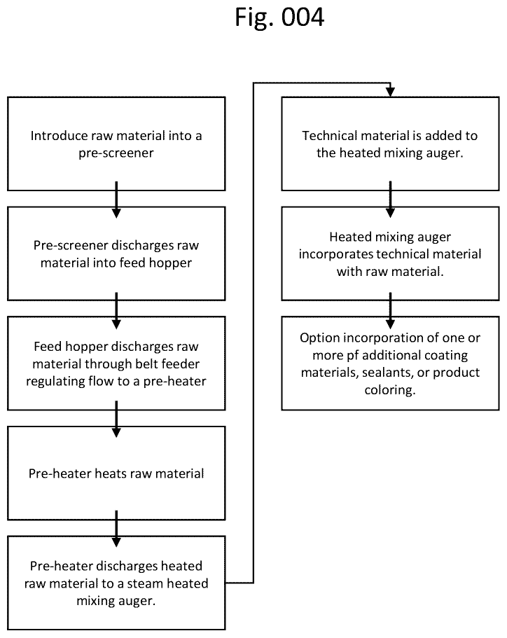

FIG. 002 shows a schematic of the components used in an exemplary method of applying powder or liquid additive to a substrate granule, such as a fertilizer granule, including the heated auger assembly 100 and FIG. 004 shows a process flow chart of an exemplary method of applying powder or liquid additive to a fertilizer granule using a heated auger assembly 100. An exemplary method of applying powder or liquid additive to a substrate granule includes introducing substrate granules into a heated auger assembly 100 via a substrate inlet 110, heating said granules to an elevated temperature, while simultaneously providing a coating thereon. An exemplary method of applying powder or liquid additive to a substrate granule includes first introducing substrate granules into a pre-screener (not shown), which then feeds the substrate granules into a hopper (not shown). The hopper discharges the substrate granules through a belt feeder (not shown), regulating flow to a pre-heater 300, such as a fluidized bed. In exemplary embodiments, a gas burner and blower unit operate the fluidized bed to create conditions allowing for the preheating of the substrate. In exemplary embodiments, the operating temperature of the pre-heater 300 is between 150-240° F., and preferably 235° F. The substrate granules are then discharged from the pre-heater 300 into a heated auger assembly 100 as described in further detail above.

In exemplary embodiments, the powdered or granular additive enters the heated auger assembly 100 though the powdered or granular additive inlet 130. In exemplary embodiments, powdered or granular additive, such as DCD powder, first passes through a mill 240 to grind the powdered or granular additive material to desired size. In exemplary embodiments, the granular additive has an average diameter of 100-5000 microns, and preferably 400-2500 microns. The ground powdered or granular additive is collected by a cyclone 210, including a dust collector 230, and discharged to the powder feeder 220, which regulates introduction of the powdered or granular additive to the heated auger assembly 100 through one or more inlet(s) 130 at a prescribed rate. In exemplary embodiments, the prescribed rate is 10-100 lbs. of granular additive per ton of substrate. In further exemplary embodiments, the prescribed rate is 15-50 lbs. of granular additive per ton of substrate.

In exemplary embodiments, the heated auger assembly 100 applies heat to the substrate granules. In exemplary embodiments, the heated auger assembly 100 applies heat to the substrate granules by way of the steam jacket 146 and steam injector 148, to maintain the desired temperature as the substrate granules and powdered or granular additive are continually mixed and moved through the mixing auger 140 and facilitating the coating of the substrate granules with powdered substrate. Although use of steam is disclosed herein, in some exemplary embodiments the mixing auger 140 may be heated by any other means capable of providing heat thereto.

In exemplary embodiments, the method includes application of additional liquid additives, such as sealants, or colorants onto the substrate granules via one or more of the inlets 120, 122, 124, within the mixing auger 140, as described further above, prior to the product exiting the heated auger assembly 100 through the product outlet 150. In exemplary embodiments, liquid additives, applied between 1-50 lbs./ton, are introduced into the process flow through at least one of a liquid inlet 120. In exemplary embodiments, a colorant is introduced via a colorant inlet 124 in an amount between 1-50 lbs. of colorant per ton of substrate, and preferably 2-25 lbs. of colorant per ton of substrate. In exemplary embodiments, the sealant additive is added to the mixing auger following the addition of a solid additive and before the addition of a liquid additive. In some exemplary embodiments, the sealant additive is added to the mixing auger following the addition of a solid additive, then a colorant is introduced via the colorant inlet 124, and then a second sealant is added. In some exemplary embodiments, a colorant is added to the mixing auger following the addition of a solid additive. In some exemplary embodiments, a colorant is added to the mixing auger via the colorant inlet 124 following the addition of a solid additive, and then a sealant is added following the addition of a colorant via the colorant inlet 124.

What have been described above are examples. It is, of course, not possible to describe every conceivable combination of components for purposes of describing the examples of the disclosure described herein, but one of ordinary skill in the art will recognize that many further combinations and permutations of the examples are possible. Accordingly, the examples described herein are intended to embrace all such alterations, modifications and variations that fall within the scope of the appended claims and the application. The terms “powdered” and “granular” are used interchangeably herein. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A heated auger assembly comprising:
a mixing auger, comprising a first end and a second end, at least one substrate inlet proximate to the first end, a product outlet proximate to the second end, and at least one additive inlet between the first end and the second end; and
a steam jacket surrounding at least a portion of an outer surface of the mixing auger, and at least one of a steam injector, wherein the steam jacket comprises at least one of a steam line extending along a length of the outer surface of the mixing auger, and wherein the steam jacket is capable of increasing the temperature within the mixing auger, such that a substrate contained within the heated auger assembly is heated to 150-240° F. as the substrate is moved through the mixing auger.

2. The heated auger assembly of claim 1, wherein the mixing auger further comprises a plurality of pitch lifting flights within an inner portion of the mixing auger.

3. The heated auger assembly of claim 2, wherein the mixing auger further comprises 15-30 pitch lifting flights.

4. The heated auger assembly of claim 1, wherein the mixing auger comprises three steam injectors, and wherein the steam injectors apply steam within the heated auger assembly at a pressure of 5-50 psi.

5. The heated auger assembly of claim 1, wherein the heated auger assembly further comprises at least one of a liquid additive inlet, a sealant inlet, and a colorant inlet between the first end and the second end.

6. The heated auger assembly of claim 5, wherein the heated auger assembly comprises a sealant inlet and a colorant inlet between the first end and the second end.

7. A process for coating a substrate with an additive, comprising:
providing a heated auger assembly, the heated auger assembly comprising:
a mixing auger, comprising, a first end, a second end, a substrate inlet, an additive inlet, and a product outlet, and
a steam jacket surrounding at least a portion of an outer surface of the mixing auger,
introducing the substrate into the mixing auger through the substrate inlet,
softening the outer surface of the substrate by applying heat within the mixing auger, wherein steam is introduced to the steam jacket, elevating the temperature within the steam jacket, thereby causing the temperature within the mixing auger to increase to 150-240° F.;
introducing a granular additive into the mixing auger; and
coating the substrate with the granular additive via rotation of the mixing auger, wherein the softening of the outer surface of the substrate facilitates an increased adhesion of the granular additive on the outer surface of the substrate.

8. The process of claim 7, further comprising preheating the substrate to a temperature of 230-240° F. prior to introducing the substrate into the mixing auger.

9. The process of claim 7, wherein the substrate is a fertilizer granule or plant nutrient.

10. The process of claim 8, wherein the substrate is a granular urea.

11. The process of claim 7, wherein the additive is a powdered or finely granulated solid.

12. The process of claim 7, wherein the additive is granular dicyandiamide (DCD).

13. The process of claim 7, wherein the additive is any one of a solution, a slurry of suspended solids, or any other liquid form.

14. The process of claim 7, further comprising coating the substrate with one or more of a solid additive, liquid additives, or a combination thereof.

15. The process of claim 14, further comprising coating the substrate with granular additive thereon with at least one of a sealant additive.

16. The process of claim 15, in which the sealant additive is added to the mixing auger following the addition of a solid additive and before the addition of a liquid additive.

17. The process of claim 7, wherein the mixing auger further comprises a plurality of pitch lifting flights within an inner portion of the mixing auger.

18. The process of claim 7, further comprising applying steam into the mixing auger through at least one of a steam injector at a pressure of 10-15 PSI.

19. A process for coating a fertilizer substrate with an additive, comprising:
providing a heated auger assembly, the heated auger assembly comprising:
a mixing auger, comprising, a first end, a second end, a substrate inlet, an additive inlet, and a product outlet, and
a steam jacket surrounding at least a portion of an outer surface of the mixing auger, and
at least one of a steam injector;
introducing the fertilizer substrate into the mixing auger through the substrate inlet,
softening the outer surface of the fertilizer substrate by applying heat within the mixing auger, wherein steam is introduced to the steam jacket at 90 PSI at a feed rate of 5-10 tons per hour, elevating the temperature within the steam jacket, thereby causing the temperature within the mixing auger to increase to 150-240° F.;
applying steam into the mixing auger through the at least one steam injector at a pressure of 10-15 PSI;
introducing dicyandiamide (DCD) into the mixing auger at a rate of 20-25 lbs DCD per ton of fertilizer substrate; and
coating the fertilizer substrate with the DCD for 0.5-5 minutes by rotating the mixing auger at a rate of 20-60 revolutions per minute, wherein the softening of the outer surface of the fertilizer granule facilitated by the increased heat within the mixing auger increases the coating reception of the DCD thereon.

20. A coated fertilizer product prepared via the process set forth in claim 7.
